(19) United States
(12) Patent Application Publication
(10) Pub. No.: US 2005/0021439 A1
(43) Pub. Date: Jan. 27, 2005

(54) Arcade casino and home investment system

(76) Inventor: Louis J. Pinga, West Warwick, RI (US)

Correspondence Address: BARLOW, JOSEPHS & HOLMES, LTD., 101 DYER STREET, 5TH FLOOR, PROVIDENCE, RI, 02903, US

(21) Appl. No.: 10/921,240

(22) Filed: Aug. 18, 2004

Related U.S. Application Data
(63) Continuation-in-part of application No. 09/544,150, filed on Apr. 6, 2000.
(60) Provisional application No. 60/128,597, filed on Apr. 9, 1999.

(51) Int. Cl. G06F 17/60

(52) U.S. Cl. 705/36

(57) ABSTRACT

A casino betting, rating and investment system is provided for allowing casino patrons to deposit cash, and/or certain portions of “rating” points and/or casino wagers into special casino investment accounts that could then be transferred to a conventional financial institution investment account, such as a Mutual Fund, IRA, Roth IRA, SEP, or Keogh. The system is provided as an incentive to the patron for maintaining patron loyalty and as a means of increasing patron regular savings and/or retirement savings. Patrons of a casino employing the present system will be provided with a casino investment account, into which deposits can be made by various methods. For example, in an arcade style casino environment, none of the games actually pay out and a fixed preselected portion of each of the patron's bets is earmarked as “investment” a bet that is deposited directly to the patron's investment account. This system is ultimately intended to provide casino style entertainment while educating patrons regarding gambling and the need for saving.

### CROSS-REFERENCE TO RELATED APPLICATIONS

This application is a continuation in part of and claims priority from earlier filed U.S. patent application Ser. No. 09/544,150, filed Apr. 6, 2000, earlier filed U.S. Provisional Application No. 60/128,597, filed Apr. 9, 1999.

### BACKGROUND OF THE INVENTION

The instant invention relates to a business method for casinos to attract patrons and retain their loyalty, and more specifically, the invention relates to an investment system for casino betting wherein casino patrons can establish a casino investment account and deposit winnings or rating points into the casino investment account.

In order to maintain patron loyalty, many casinos have developed a rating system or “comp” system, wherein casino patrons are provided with a rating card, and depending on the time spent in the casino, or the accumulated amount of money bet over a period of time, the casino will award “comp” or rating points. For example, a patron may be awarded 1 rating point for every certain dollar value bet on a gaming table. Rating points are accumulated in the patrons rating account and can be exchanged for or credited towards casino services and/or goods, such as hotel accommodations, meals and souvenirs. These casino rating systems have become widespread and have been found to increase patron loyalty by giving the patron an incentive to return to the casino, i.e. to redeem points awarded at an earlier date. Typically, most casinos don't make rating points immediately available for redemption. The rating points accumulated on one visit would be available for the next visit.

In the past, when there were relatively few licensed casinos in the United States, patron loyalty was important, but not critical to casino revenues. While it was important to maintain a regular repeat customer base, the casino did not count on such repeat customers to make large profits. This was largely true because there were only so many licensed casinos and there were more than enough customers to provide all of the casinos with a sufficient customer base. However, recent dramatic increases in the number of casinos around the country has increased competition among casinos and there is now a push to develop systems that will maintain loyalty among regular repeat customers.

There is therefore a need for a system that will attract customers and build loyalty among customers in a manner that entices those customers to return to the casinos on a frequent basis while establishing strong brand identity and loyalty relationships.

### BRIEF SUMMARY OF THE INVENTION

In this regard, the instant invention provides a unique casino betting and rating system that allows casino patrons to deposit certain portions of rating points and/or casino winnings into special casino investment accounts that could then be transferred to a conventional financial institution investment account, such as a Mutual Fund, IRA, Roth IRA, SEP, or Keogh, as a means of increasing patron regular savings and/or retirement savings.

More specifically, patrons of a casino employing the present system will apply for a casino investment account, into which deposits can be made by various methods. For example, a selected portion of a patron's bets can be earmarked as “pension” or “investment” bets, these bets being placed on tables and paid out with differently marked chips. Any winnings from these bets could be placed into the casino investment account maintained by the casino. Alternatively, “comp” or “rating” points accumulated through normal betting could be exchanged and deposited into the casino investment account. In an alternate embodiment the establishment may be configured as an entertainment establishment only. In this establishment none of the games pay out but as the player pays to play the machines, a portion of the deposited money goes directly into the player's investment account.

The casino operation can choose to establish and maintain investment services, essentially becoming a financial institution, or alternatively can establish a relationship with an existing financial institution whereby the patron's casino investment account is tied to a corresponding investment or retirement account maintained by a financial institution. These “Investment” accounts would comprise conventional IRA's, variable annuities or any other commonly available financial instrument which would accumulate interest, dividends capital gains, etc. over time and be drawn upon at a later date.

In the case of the casino establishing itself as a financial institution, the investment accounts would be invested into mutual funds, IRA's etc. at the direction of the patron.

In the case of an outside financial institution, once a certain minimum balance is reached in the casino investment account the patron could request that the amount be transferred into their “retirement account” or “investment account” at the financial institution in the same way regular businesses and individuals make deposits into investment accounts.

Accordingly, among the objects of the instant invention are: the provision of a casino betting and rating system that will increase casino patron loyalty; the provision of a casino betting, rating and investment system that permits a patron to deposit rating points or earmarked “investment” winnings into a casino investment account as means of increasing patron regular savings or retirement savings; and the provision of a casino betting, rating and investment system that associates the casino investment account with an established investment account of a financial institution.

Other objects, features and advantages of the invention shall become apparent as the description thereof proceeds when considered in connection with the accompanying illustrative drawings.

### BRIEF DESCRIPTION OF THE DRAWINGS

In the drawings which illustrate the best mode presently contemplated for carrying out the present invention:

FIG. 1 is a schematic illustration of the casino betting, rating and investment system in accordance with the teachings of the present invention;

FIG. 2 is a flow chart illustrating the flow of cash deposits;

FIG. 3 is a flow chart illustrating the flow of deposits when using casino “investment chips”;

FIG. 4 is a flow chart illustrating the use of investment rating points for deposit;

FIG. 5 is a flow chart illustrating the use of conventional rating points for deposit; and

FIG. 6 is a flow chart illustrating the conversion of conventional rating points for investment rating points and subsequent deposit.

### DETAILED DESCRIPTION OF THE INVENTION

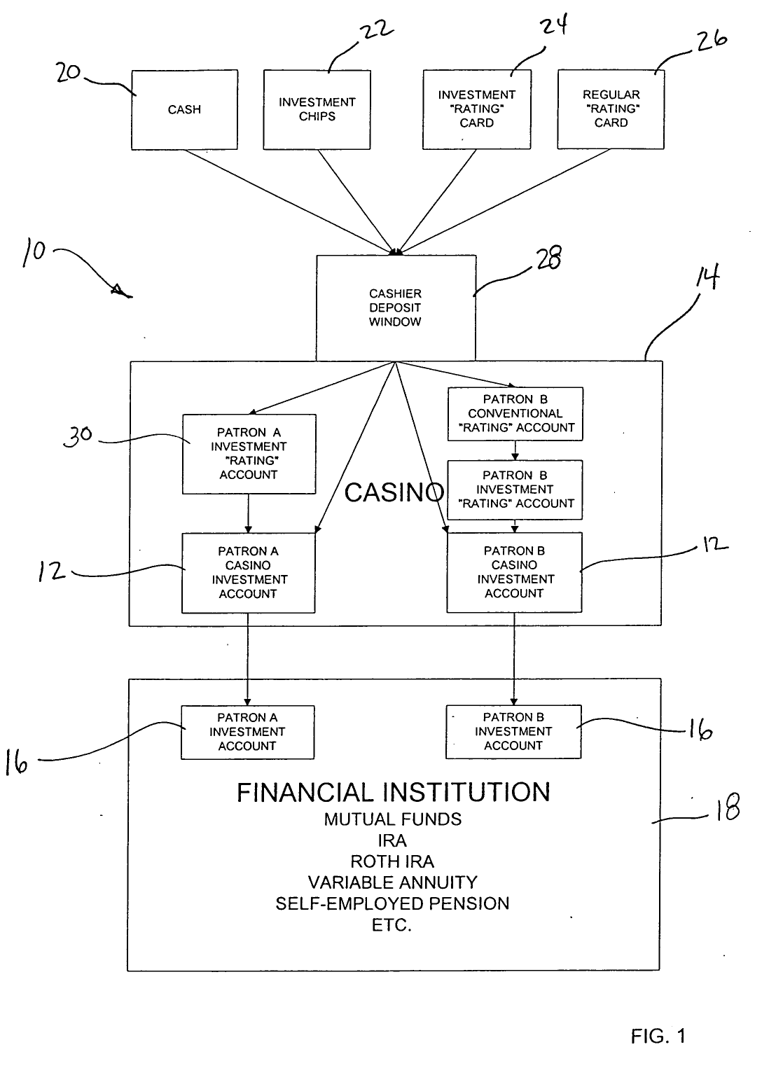

Referring now to the drawings, the casino betting, rating and investment system of the instant invention is schematically illustrated and generally indicated at 10 in FIG. 1. As will hereinafter be more fully described, the instant invention provides a unique casino betting, rating and investment system 10 that allows casino patrons to deposit certain portions of rating points and/or casino winnings into special casino investment accounts 12 that are maintained by a casino 14. Deposits into the casino investment accounts 12 could then be transferred to a conventional financial institution investment account 16, such as a Mutual Fund, IRA, Roth IRA, SEP, 529 Education or Keogh, maintained by a financial institution 18. While various types of investment accounts 16 are listed above, clearly the present invention is not limited to those type accounts listed and is intended to include any appropriate type of investment vehicle. The system 10 would serve as a marketing tool as a means of increasing patron loyalty while also providing a public service benefit by increasing the patrons regular savings and/or retirement savings.

More specifically, patrons of a casino 14 employing the present system will apply for a casino investment account 12, into which deposits can be made by various methods. For example, a selected portion of a patron's bets can be earmarked as “investment” or “pension” bets, these bets being placed on tables and paid out with differently marked chips. Any winnings from these bets could be placed into the casino investment account 12 maintained by the casino 12. Alternatively, “comp” or “rating” points accumulated through normal betting could be exchanged and deposited into the casino investment account 12.

The casino 14 can choose to establish and maintain investment services, essentially becoming a financial institution., or more likely, can establish a relationship with an existing financial institution 18 whereby the patron's casino investment account 12 is tied to a corresponding investment or retirement account 16 maintained by the financial institution 18. These “investment” accounts 16 comprise mutual funds, conventional IRA's, variable annuities or any other commonly available financial instrument which would accumulate interest, dividends capital gains, etc. overtime and be drawn upon at a later date.

In the case of the casino 14 establishing itself as a financial institution, the investment accounts 12 would be directly invested into mutual funds, IRA's etc. at the direction of the patron.

In the more likely case where the casino 14 associates itself with an independent financial institution 18, once a certain minimum balance is reached in the casino investment account 12 the patron could request that the amount be transferred into their “investment account” 16 at the financial institution 18 in the same way regular businesses and individuals make deposits into investment accounts. For purposes of description of the remaining portions of the system, it is assumed that the casino is associated with an outside financial institution 18 that handles actual investment of the money into financial instruments. This is not to be construed as a limitation of the present system, but only as a representative example of a preferred embodiment.

Referring now to FIGS. 1-6, deposits can be made into the casino investment account 12 in many different ways, including direct cash deposits 20, by buying and cashing in special “investment chips” 22, by redeeming special “investment” rating points 24, or by redeeming conventional rating points 26 for equivalent values of cash or investment rating points. All deposits and transactions concerning the casino investment account 12 would be conducted through a casino cashier's window 28 or a special customer service window located on casino premises and dedicated to conducting such transactions. By requiring the transactions to be handled on casino premises, the casino requires that the patron return to the casino multiple times and creates a repeat customer base.

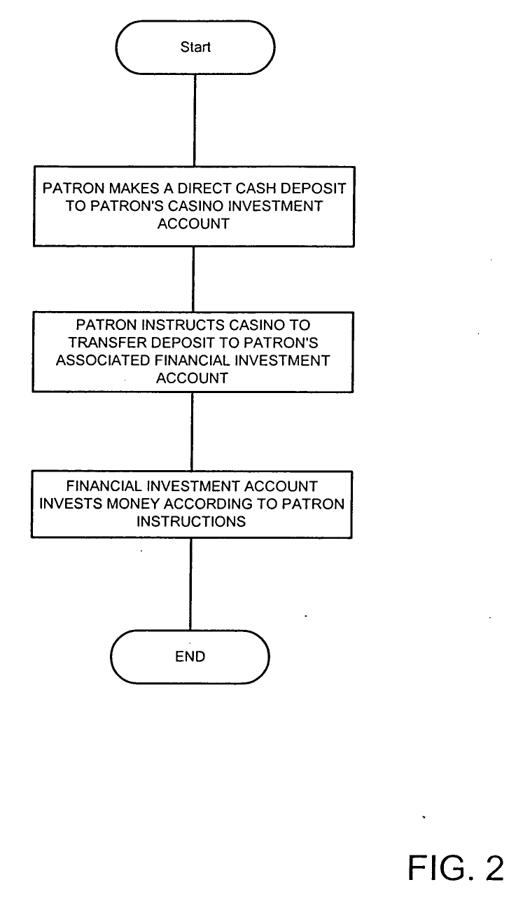

Referring now to FIG. 2, the casino patron can deposit cash directly into the casino investment account. Any cash deposited is held in trust until a specified minimum dollar value is reached, at which time, the patron can instruct the casino 14 to transfer the deposits into the patrons associated Investment account 16. The patron would later contact the financial institution 18 to provide instructions on actual investment of the balance in the investment account 16.

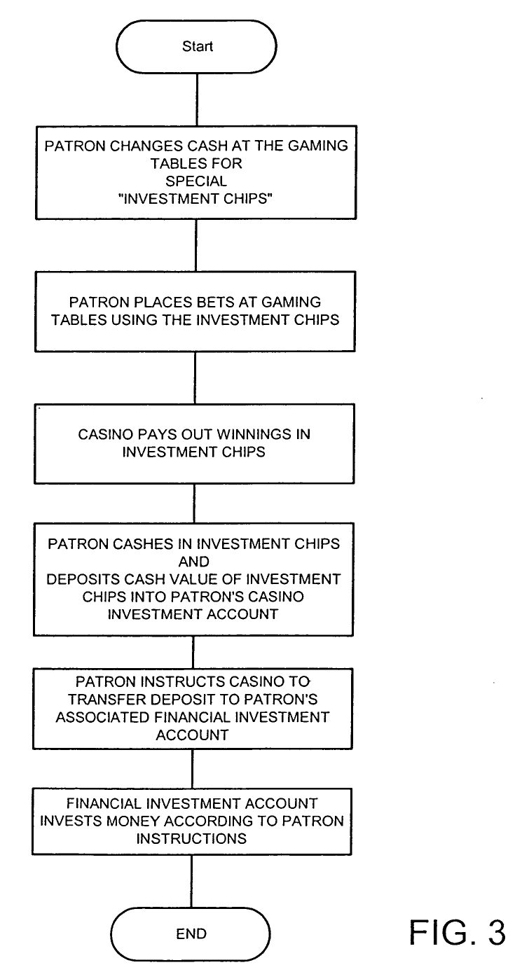

Referring to FIG. 3, the casino could establish a separate set of “pension chips” or “investment chips”. Patrons may change in for these special investment chips at the gaming tables and proceed to place bets in the usual manner. On regular gaming tables, such as Blackjack or Craps, the investment chips would be used in place of regular chips. On a roulette table, which uses different colored chips to designate different players, the player would “color in”, i.e. change, the colored chips for the investment chips before leaving the table. Winnings from bets made with the investment chips would be paid out in investment chips. The investment chips could then be cashed in at the cashier's window 28 and directly deposited into the patron's casino investment account 12.

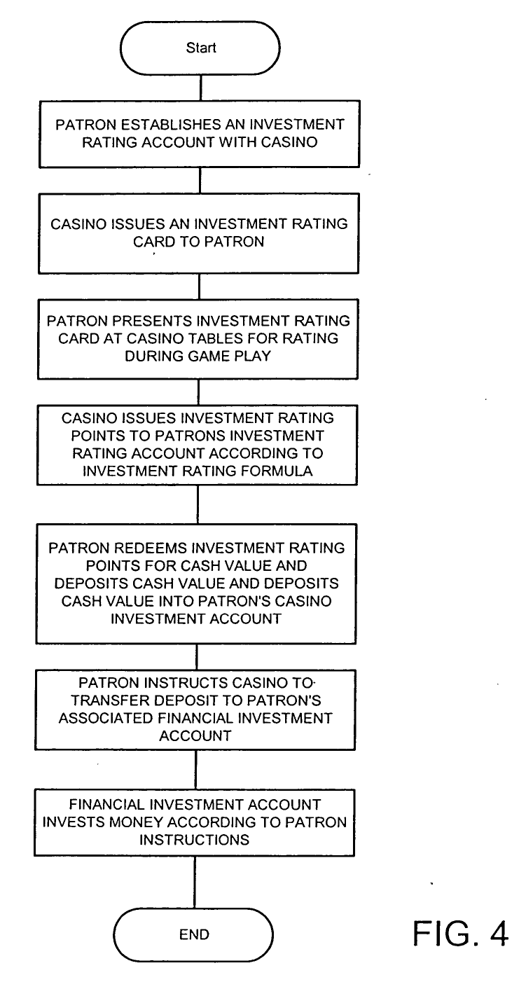

Referring to FIG. 4, the casino 14 can establish a separate “investment rating system” wherein “investment rating points” are accumulated in a special investment rating account 30. As is well known in the casino world, casinos will award rating points to patrons based on accumulated dollar amounts of betting. For example, a patron may be awarded 1 rating point for every certain dollar value bet on the table. Rating points are typically used for buying casino services or goods, such as hotel accommodations and meals. The patron would establish an investment rating account 30 with the casino 14, which would then issue a special “investment rating card”. The patron will present the investment rating card at the gaming tables where the patron will accumulate investment rating points as the patron places bets in the casino. The investment rating points are issued according to an investment rating formula established by the casino. The investment rating points would be issued to the patron and accumulated in the patron's account 30 over time. When a certain minimum threshold limit is reached, the investment rating points are redeemed and transferred to the patron's casino investment account 12. Deposits in the casino investment account in turn are transferred to the Patron's associated financial institution “investment account” 16.

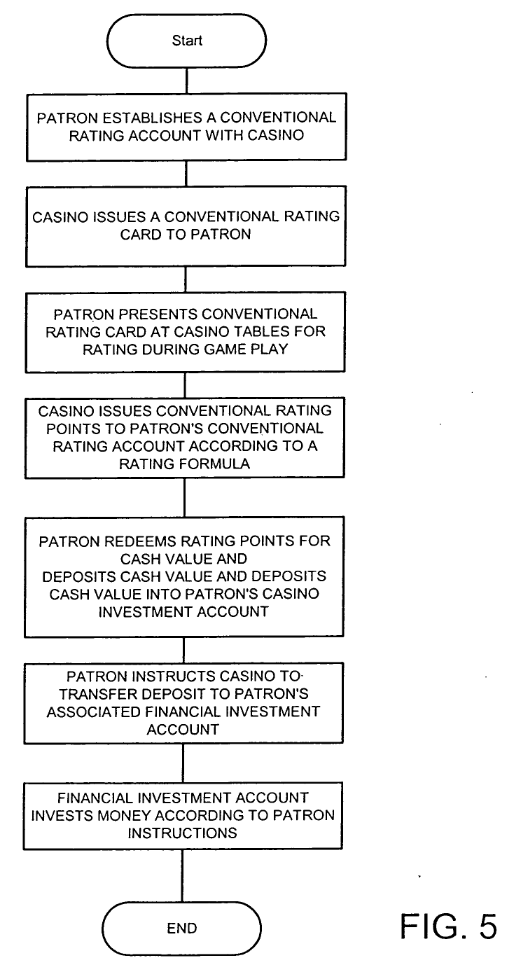

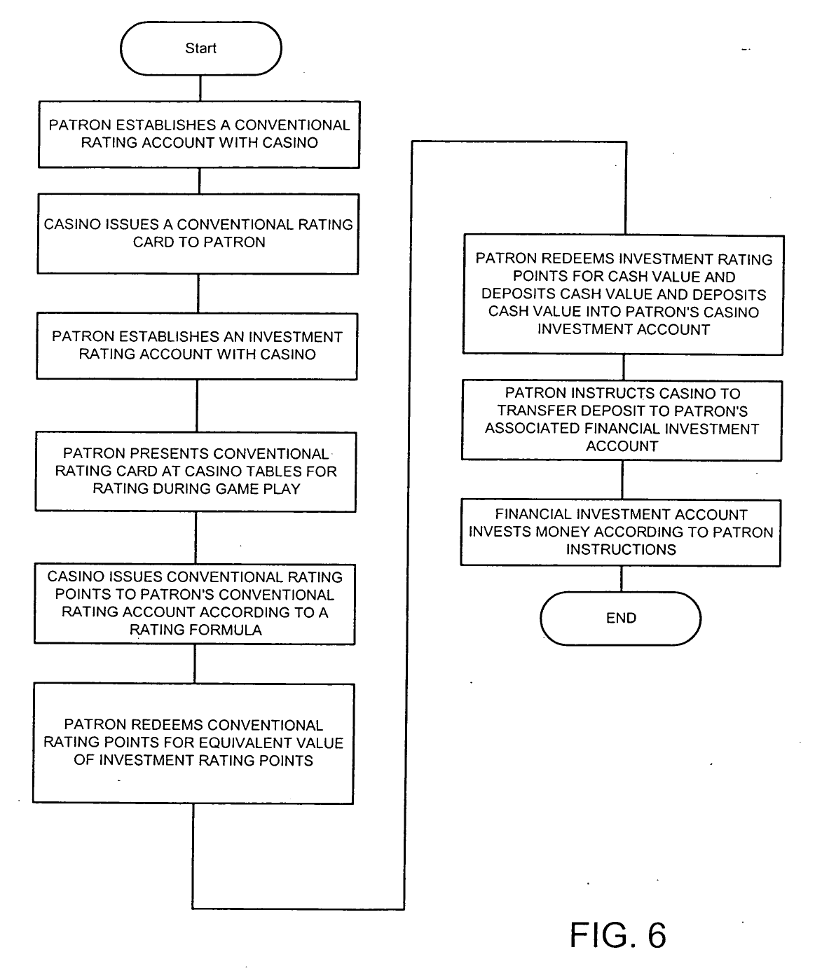

Referring now to FIG. 5 and 6, the casino can utilize its existing or “conventional” rating system with the present system by establishing direct exchange rates for redeeming conventional rating points for a cash value for deposit into the casino investment account 12, or an exchange rate for converting the conventional rating points for investment rating points which can then in turn be redeemed for a cash value deposit into the casino investment account 12.

Similarly, a casino type environment may be established wherein all of the games provided in a casino 14 are provided in an entertainment only or educational setting. Ultimately, this setting would have a casino like atmosphere but operate much more like an arcade. Players would play all of the games by depositing a wager; however, ultimately the games would not provide any payout. In lieu of a payout, a fixed percentage of the actual dollars wagered would be deposited directly into the patron's account 30 which would then be periodically wired to the patron's investment account 12. In this case a patron would enter the arcade casino 14 and exchange cash for chips, tokens, magnetic strip cards or any other suitable exchanges system. For example, a user would purchase 100 $1.00 chips for $100. The chips would allow the patron to play any of the games in the arcade casino 14 venue. In contrast to the typical casino however, none of the games would provide a payout. In lieu of a payout, the arcade casino would subtract a portion of the money wagered for profit and overhead expenses and the balance of the money wagered by the patron would be placed into the patron's account 30. For example, if the patron wagered $100, $30 would be retained by the arcade casino and $70 would be deposited into the patron's account 30 for later transfer to an investment account 12. Similarly, while an example of one possible arrangement is provided above for illustrative purposes clearly various other calculations may be utilized to arrive at the business overhead and player payout percentages and still fall within the present invention.

In an alternate embodiment, a patron may select to have a slot machine placed into their home. The slot machine 14 may be purchased or placed into the home by a management company. The patron plays the machine 14 in a traditional manner by placing money into the machine and playing the game. In contrast to a true casino, however, the money deposited is collected from the machine and placed into an investment account 12 or the benefit of the patron. In the case of a management company, the management company may issue a receipt to the patron each time the money is retrieved from the machine so that the patron may verify the amount of funds that should be deposited into their investment account 12. Further, as stated above, when a management company collects the money, a percentage of that money may be retained as a fee for providing the machine 14 and for providing the service related to the funds collection and investment. Accordingly, the remaining balance will then be deposited into the patron's investment account 12.

Additionally, in the arcade casino type scenario, each of the games includes a digital display that provides educational information to the patron relative to the odds of winning or losing when gambling. After each play, hand or round of gaming activity, the machine or dealer informs the patron whether or not they hypothetically won or lost that round. Additionally, the machine or dealer would inform the patron what the odds of winning or losing were and provide information regarding the total amount that the patron had to actually gamble to win that particular payout. Further the display may provide a calculation showing the patron the amount of money that would have been lost at an actual casino versus the actual money saved by participating in the arcade casino venue. The goal is ultimately to educate a gambler regarding the need to save while also providing an alternate venue for casino style entertainment without the overall risk of loss.

It can therefore be seen that the present invention provides a unique and financially valuable betting, rating and investment system for use in casinos. The system serves as an effective and attractive marketing tool to increasing patron loyalty while also providing a valuable public service benefit by increasing the patron's regular savings and/or retirement savings. For these reasons, the instant invention is believed to represent a significant advancement in the art which has substantial commercial merit.

While there is shown and described herein certain specific structure embodying the invention, it will be manifest to those skilled in the art that various modifications and rearrangements of the parts may be made without departing from the spirit and scope of the. underlying inventive concept and that the same is not limited to the particular forms herein shown and described except insofar as indicated by the scope of the appended claims.

1. A method for implementing a casino style patron expenditure tracking and investment program based on patron game play, said method comprising the steps of:
establishing an investment account for the benefit of a game play patron;
collecting money from said game play patron;
exchanging said money collected from said game play patron for credits that allow said game play patron to play casino style games;
making a deposit into said investment account based on a percentage of the value of money collected from said patron;
associating said investment account with a financial investment account of said casino patron;
redeeming said deposits from said investment account; and
transferring said redeemed deposits into said financial investment account.

2. The method of claim 1 wherein said step of making a deposit comprises the step of depositing cash into said investment account.

3. The method of claim 1 wherein said step of making a deposit comprises the steps of:
establishing a formula for calculating the cost of operating the game play venue;
establishing a formula for calculating a fair profit for operating the game play venue;
calculating said percentage of collected money to be deposited by subtracting said cost of operating and said fair profit from said collected money; and
depositing said calculated portion of collected money into said investment account.

4. The method of claim 1 wherein said financial investment account is operated and maintained by an independent financial institution.

5. The method of claim 1 wherein said money transferred into said financial investment account is accrued on a tax deferred basis.

6. The method of claim 1, further comprising:
educating said game play patron regarding said casino style games.

7. The method of claim 6 wherein said step of educating said game play patron further comprises:
providing periodic information to said game play patron during game play, wherein said periodic information provides said game play patron with the relative odds against winning such a game.

8. The method of claim 7 wherein said step of educating said game play patron further comprises:
providing a comparison between the relative odds against winning such a game and the actual money saved by said game play patron by making said deposit into said investment account.

9. The method of claim 6 wherein said step of educating said game play patron further comprises:
providing periodic information to said game play patron during game play, wherein said periodic information provides said game play patron with the actual expenditures necessary to win such a game.

10. The method of claim 8 wherein said step of educating said game play patron further comprises:
providing a comparison between the expenditures necessary for winning such a game and the actual money saved by said game play patron by making said deposit into said investment account.

11. A method for implementing an in home slot machine investment program based on patron game play, said method comprising the steps of:
establishing an investment account for the benefit of a game play patron;
providing a slot machine for placement in the home of the game play patron, wherein said game play patron deposits money into said slot machine to play said slot machine;
collecting the money from said slot machine; and
depositing said collected money into said financial investment account.

12. The method of claim 11, wherein said step of collecting said money includes a management service collecting said money, said management company issuing a receipt for the amount of money collected.

13. The method of claim 11, further comprising the step of:
issuing a receipt corresponding to the amount of money collected from the slot machine.

14. The method of claim 11, wherein said financial investment account is operated and maintained by an independent financial institution.

15. The method of claim 11 wherein said money transferred into said financial investment account is accrued on a tax deferred basis.

16. The method of claim 11, further comprising the step of:
educating said game play patron regarding said casino style games.

17. The method of claim 16 wherein said step of educating said game play patron further comprises:
providing periodic information to said game play patron during game play, wherein said periodic information provides said game play patron with the relative odds against winning such a game.

18. The method of claim 17 wherein said step of educating said game play patron further comprises:
providing a comparison between the relative odds against winning such a game and the actual money saved by said game play patron by making said deposit into said investment account.

19. The method of claim 17 wherein said step of depositing said collected money comprises the steps of:
establishing a formula for calculating the cost of providing and managing the slot machine;
establishing a formula for calculating a fair profit for providing and managing the slot machine;
calculating said percentage of collected money to be deposited by subtracting said cost of providing and managing the slot machine and said fair profit from said collected money; and
depositing said calculated portion of collected money into said investment account.
